(19) United States
(12) Patent Application Publication
(10) Pub. No.: US 2026/0326586 A1
(43) Pub. Date: Oct. 22, 2026

(54) CHARGING CONNECTOR FOR AN ELECTRIC OR HYBRID VEHICLE

(71) Applicant: Kiekert Aktiengesellschaft, Heiligenhaus (DE)

(72) Inventors: Ingo NÖVERMANN, Mülheim an der Ruhr (DE); Michael BERRES, Köln (DE)

(73) Assignee: Kiekert Aktiengesellschaft, Heiligenhaus (DE)

(21) Appl. No.: 19/108,791

(22) PCT Filed: Sep. 12, 2023
(86) PCT No.: PCT/DE2023/100674

§ 371 Date: Mar. 5, 2025

(30) Foreign Application Priority Data
Sep. 26, 2022 (DE) 10 2022 124 712.0

(51) Int. Cl. B60L 53/16; B60L 53/66; B60R 16/03; E05F 15/611

(52) U.S. Cl. CPC B60L 53/16; B60L 53/66; B60R 16/0315; E05F 15/611; E05Y 2900/534

(57) ABSTRACT

The invention relates to a charging connector (1) for an electric or hybrid vehicle, having a housing (2), charging contacts (3) arranged in the housing (2) for conducting electric current, and a communication module (4) for transmitting and/or receiving a serial signal. In this way, communication between a charging connector (1) for an electric or hybrid vehicle and an external device can be simplified and made more efficient.

The invention relates to a charging connector for an electric or hybrid vehicle, having a housing and charging contacts arranged in the housing for conducting electric current.

Electric and hybrid vehicles have a rechargeable energy storage device, usually a high-voltage battery, which provides energy to an electric drive motor during driving operation. The storage capacities of these high-voltage batteries are limited so that they must be regularly recharged at a charging station. The battery is charged via a charging cable provided between the charging station and the vehicle, wherein the charging cable is provided on one side with a charging plug that can be plugged into a charging socket provided on the charging station, and on the other side with a charging coupling that can be connected to a built-in charging plug installed in the electric and hybrid vehicle, for example in accordance with the European standard IEC 62196. In the present case, charging sockets, charging plugs, charging couplings, and built-in charging plugs are subsumed under the term “charging connector.” Charging sockets and charging couplings have contact sleeves as charging contacts, and charging plugs as well as built-in charging plugs that can be installed in electric and hybrid vehicles have contact pins as charging contacts that can be plugged into the contact sleeves.

The plug contacts between a built-in charging plug and a charging coupling are subject to increased wear on the surface due to frequent use and repeated plugging and unplugging. This wear leads to an increase in contact resistance, which can cause significant heat generation during the charging process.

Charging connectors for electric and hybrid vehicles are subject to legal and user-specific requirements regarding the temperature monitoring of AC and DC charging contacts. For direct current charging, a temperature measurement is usually required on both DC charging contacts. For this purpose, a component suitable for temperature measurement, usually an NTC resistor, is brought as close as possible to the heat source, i.e., the charging contact, in order to make real-time temperature monitoring for charging optimization and safety monitoring possible. An NTC resistor is a resistor that is used in electronic components. It is also called a thermistor or NTC thermistor. The abbreviation “NTC” stands for “negative temperature coefficient” and describes the property of thermistors to conduct current better as the temperature increases, since they have a negative temperature coefficient.

PTC resistors are also known. A PTC resistor, also known as a thermistor or PTC thermistor (“positive temperature coefficient”), is also a temperature-dependent resistor, but it conducts electric current better at low temperatures than at high temperatures. There are PTC resistors that have an almost linear characteristic curve (resistance as a function of the temperature). However, PTC resistors which behave non-linearly and in which the resistance increases sharply in the range of the nominal response temperature are also known. Such PTC elements can thus be used to implement a type of “safety” by returning an abruptly changing value to a reading system when the critical temperature has been exceeded.

Temperature monitoring may also be required for AC charging contacts. Depending on the standard and manufacturer specification, a real temperature measurement or only a detection of the exceedance of a temperature threshold value is required. This may be required either for all AC charging contacts (e.g., L1, L2, L3 and N for connectors in accordance with the European standard IEC 62196 Type 2) separately for each AC charging contact or bundled, i.e., for all AC charging contacts together.

DE 10 2015 106 251 A1 describes a temperature monitoring device with a carrier element extending flatly along a plane and having at least one opening. The carrier element can be designed as a circuit board. The contact elements are components of a contact assembly that can be attached as a modular unit to the plug insert. The contact assembly has a temperature monitoring device with a carrier element. The temperature monitoring device serves to detect any impermissible heating on at least the contact elements that are used to transmit large currents during operation of the plug connector part. For the necessary contacting, the carrier element has, at each of the openings, a metal coating for providing a contact surface in the form of a through-connection.

WO 2021/004765 A1 discloses an electrical assembly with a temperature monitoring device. For this purpose, a connector part with both AC charging pins and DC charging pins is provided. For monitoring possible heating, in particular at the DC charging pins, the connector part has an electrical assembly. This assembly consists of contact elements that are arranged on a carrier element and electrically connected to associated load lines. Each contact element is accommodated in an associated receiving opening of the carrier element.

Based thereon, the object of the invention is to design the communication between a charging connector for an electric or hybrid vehicle and an external device in a simple and efficient manner.

The object of the invention is achieved by the subject matter of the independent claims. Preferred developments of the invention are described in the dependent claims.

According to the invention, a charging connector for an electric or hybrid vehicle is thus provided, having a housing, charging contacts arranged in the housing for conducting electric current, and a communication module for transmitting and/or receiving a serial signal.

The basic idea of the invention is that different sensor data can be transmitted via only one or a few signal lines if a communication module is provided for transmitting and/or receiving a serial signal. In this way, the flow of information can be increased considerably, which benefits additional diagnostic requirements and performance demands.

Basically, it should be noted with regard to the charging connector according to the invention that it is intended for plugging together with a corresponding charging connector. According to a preferred development of the invention, the communication module is designed such that, when the charging connector is plugged in, it allows communication to and/or from the corresponding charging connector. In this way, communication between a charging station and an electric or hybrid vehicle connected to the charging station via a charging cable is possible.

When reference is made to a corresponding charging connector in the present case, this means, on the one hand, a charging connector which has the same connector face as the charging connector according to the invention, wherein the one connector face, however, has contact pins if the other connector face has contact sleeves, and vice versa. The set consisting of the charging connector according to the invention and the corresponding charging connector can therefore be plugged together. On the other hand, in the present case, a charging connector is also referred to as a corresponding charging connector if the connector faces in the aforementioned sense only partially correspond, i.e., the corresponding charging connector, for example, does not have all the contacts that are present in the charging connector according to the invention, but the existing contacts of the corresponding charging connector correspond to the charging connector according to the invention in terms of the connector face so that the charging connector according to the invention and the corresponding charging connector can also be plugged together in this case. Such a case occurs, for example, with a charging coupling connected to a charging cable for direct current charging in accordance with the European standard IEC 62196 Type 2. Such a charging coupling can be plugged into a built-in charging plug installed in the body of an electric or hybrid vehicle and suitable for alternating current charging as well as direct current charging, wherein the AC connector face of the DC charging coupling only has the communication contacts and the protective contact, but no contacts for outer conductors and a center conductor for alternating current charging.

In principle, the communication module can be arranged inside the housing. However, this is not absolutely necessary. In this respect, the communication module can be arranged inside or outside the housing. Arranging the communication module outside the housing can be advantageous in particular if the charging connector is a built-in charging plug that is attached to the body of an electric or hybrid vehicle. This is because in this case, there is usually enough space within the body to install the communication module without it disturbing or hindering other devices.

There are now various options for designing the communication module. According to a preferred development of the invention, the communication module comprises a multiplexer for multiplexing signals detected in or on the charging connector. Specifically, in this context, it is preferred that, on each of a plurality of charging contacts, a temperature sensor for detecting the temperature of the respective charging contact is arranged, and that the temperature sensors are connected to the multiplexer so that temperature signals originating from the temperature sensors can be transmitted to the multiplexer and converted by the multiplexer into a serial data stream. Temperature monitoring of the DC charging contacts of a charging connector for an electric or hybrid vehicle is already required by the standard (European standard IEC 62196). Preferably, however, the temperatures of the DC charging contacts should also be monitored, and preferably all AC charging contacts.

In the present case, such contacts are referred to as DC charging contacts, which are intended exclusively for charging with direct current. Such DC charging contacts heat up notably when charging with high currents. In contrast to DC contacts, there are AC charging contacts. This refers to the outer conductors as well as the neutral conductor (center conductor), which are also intended for charging with alternating current. An outer conductor (also colloquially referred to as a phase) is a conductor that is voltage-carrying during normal operation and can contribute to the transmission or distribution of electrical energy but is not a neutral conductor. A neutral conductor is a conductor that is electrically connected to the neutral point and is capable of contributing to the distribution of electrical energy. In the European standard IEC 62196, the contacts that are referred to here as AC charging contacts are designated L1, L2 and L3 (outer conductors) and N (neutral conductor), and the DC charging contacts are designated DC+ and DC−. This understanding should not be contradicted by the fact that the European standard IEC 62196 also provides for an operating mode according to which direct current charging takes place via the contacts L1, L2, L3 and N.

For monitoring the temperatures of the AC charging contacts when using a temperature-dependent resistor, a separate signal line would have to be routed to an evaluation unit for each AC contact. Alternatively, a series circuit can be used, e.g., consisting of PTC elements. However, such a series circuit does not allow any conclusions to be drawn about the individual temperature of individual AC charging contacts. The use of a multiplexer now makes it possible to bundle signals and transmit them serially over a single signal line. The multiplexer can be controlled via control lines so that a corresponding channel is selected, or a periodic change of the channels is triggered via a clock generator and synchronized with the evaluation unit. In this respect, according to a preferred development of the invention, it is provided that at least one control line is connected to the multiplexer in order to control the temporal sequence of the temperature signals, originating from the temperature sensors, in the serial data stream. Alternatively, it is possible for the temperature signals originating from the temperature sensors to follow one another periodically in the serial data stream.

By using the multiplexer, many signal lines can thus be bundled into a single one. Depending on the number of inputs, an appropriate multiplexer must be selected (4:1 in the case of four inputs to one output, 8:1 in the case of eight inputs to one output, . . . ). As the number of inputs increases, the number of control lines also increases. For example, a 4:1 multiplexer requires two control lines, while an 8:1 multiplexer requires three. An advantage of the external control of the multiplexer is that only the lines that are currently of interest to the evaluation unit can be queried. Therefore, if only an AC charging process is taking place, the DC temperature sensors can be ignored and more time can be spent on the AC temperature sensors. As mentioned, alternatively, all input signals can be periodically queried and the clock of the multiplexer can then be synchronized with the evaluation unit. This reduces the number of control lines to one for the clock generator but also leads to a reduction in flexibility since each input line is now mapped to the output the same number of times and for the same length of time.

According to a preferred development of the invention, the communication module can additionally or alternatively be configured to receive digital signals. In this context, it is very particularly preferred that the communication module is configured for bidirectional communication of serial signals. In this way, the charging connector can not only transmit signals but also receive them, e.g., in order to control a device on the charging connector. In this respect, according to a preferred development of the invention, it is provided that the charging connector is additionally provided with an actuator and a control device for controlling the actuator, wherein the communication module is connected to the control device for transmitting a control signal received by the communication module.

Very particularly preferably, the charging connector is a built-in charging plug for attachment to the body of an electric or hybrid vehicle.

Furthermore, the invention also relates to the use of a previously described charging connector on the body of an electric or hybrid vehicle.

Lastly, the invention also relates to a method for communication between a charging connector for an electric or hybrid vehicle and a device other than the charging connector, wherein the communication takes place by means of a serial signal. According to a preferred embodiment of the invention, the charging connector outputs a signal converted by means of a multiplexer. Alternatively or additionally, it is preferably provided that the charging connector transmits and/or receives a digital signal. Further designs, functions and advantages of this method result in analogy to the charging connector described above.

The invention is explained in more detail below with reference to the drawings on the basis of preferred exemplary embodiments.

In the drawings,

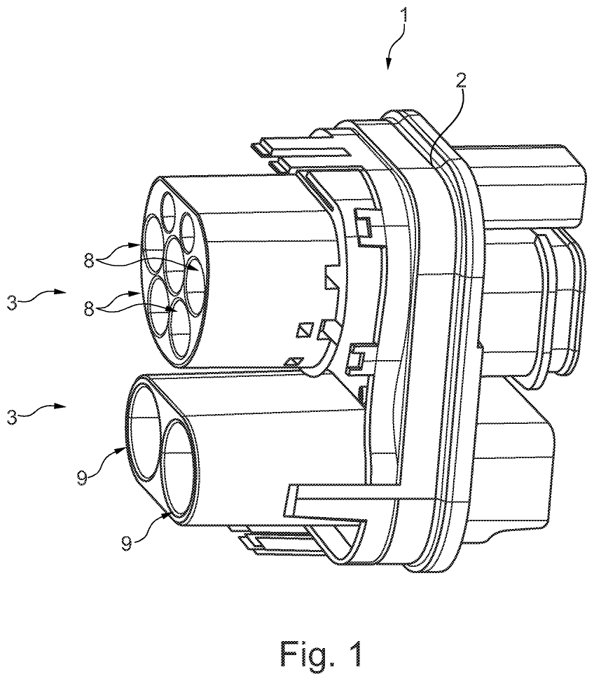

FIG. 1 is a perspective view of a charging connector according to a preferred exemplary embodiment of the invention,

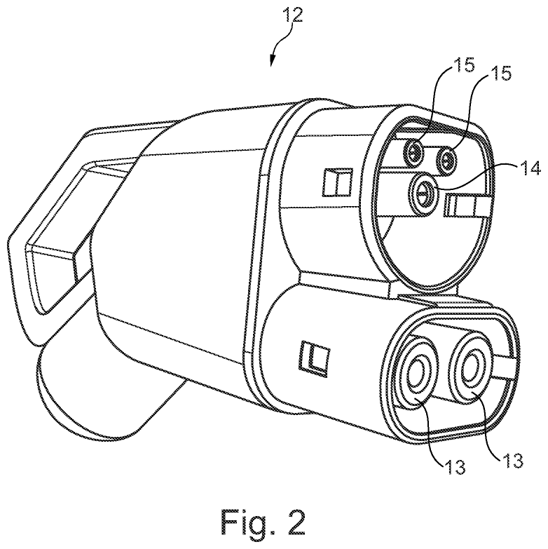

FIG. 2 is a perspective view of a charging connector corresponding to the charging connector of FIG. 1,

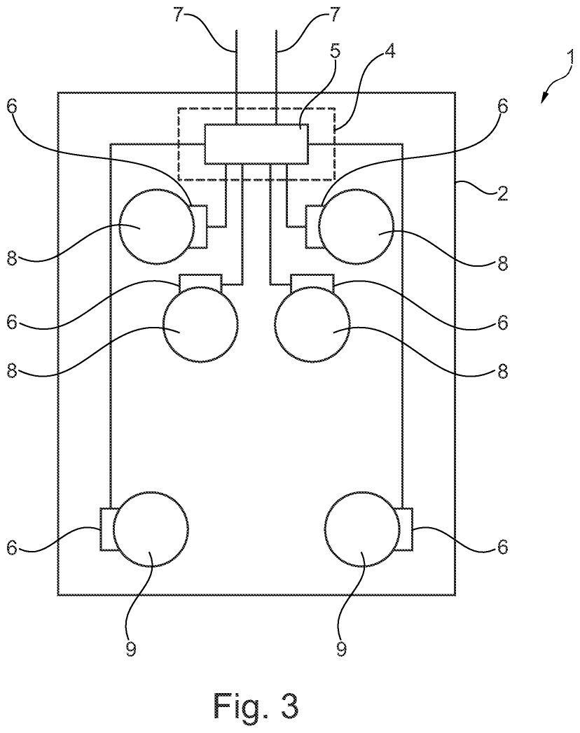

FIG. 3 schematically shows a charging connector according to a preferred exemplary embodiment of the invention with a multiplexer, and

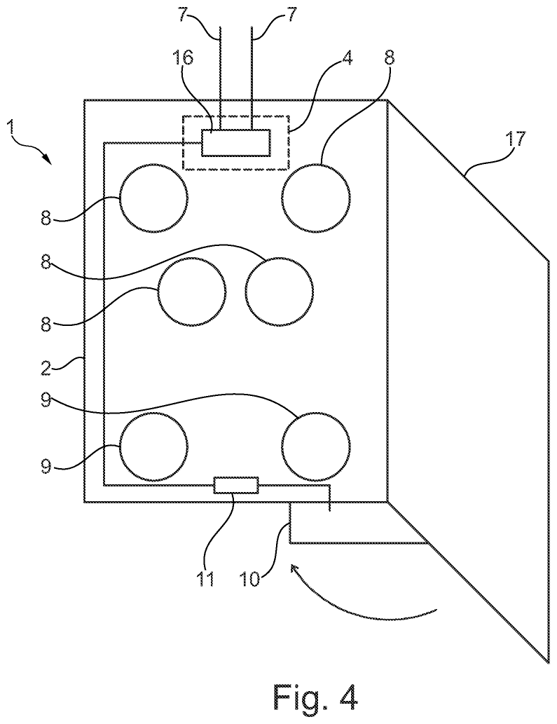

FIG. 4 schematically shows a charging connector according to a preferred exemplary embodiment of the invention with a digital part for receiving digital control data.

In FIG. 1, a charging connector 1 according to a preferred exemplary embodiment of the invention is shown in a perspective view. The charging connector 1 has a housing 2 and charging contacts 3 arranged in the housing 2. On the one hand, these charging contacts are AC charging contacts 8 for alternating current charging and, on the other hand, DC charging contacts 9 for direct current charging. The charging connector 1 shown in FIG. 1 is a built-in charging plug for installation in the body of an electric or hybrid vehicle.

The charging connector 1 can be coupled to a corresponding charging connector 12, which is shown in FIG. 2. This is a charging coupling that can be attached to a charging cable and plugged together with the built-in charging plug. The charging coupling shown here as an example is one for direct current charging and therefore has corresponding DC charging contacts 13, a protective contact 14 and signal contacts 15. Both the built-in charging plug shown here and the coupling shown here correspond in terms of their connector face to the European standard IEC 62196.

What is important now is that the built-in charging plug 1 according to a preferred exemplary embodiment of the invention is designed, for example, as shown schematically in FIG. 3:

That is to say, the built-in charging plug is equipped with a communication module 4 for transmitting a serial signal. For this purpose, the communication module 4 has a multiplexer 5 for multiplexing signals detected in the charging connector 1. Specifically, both the DC charging contacts 9 and the AC charging contacts 8 are each provided with a temperature sensor 6. The temperature sensors 6 are NTC elements in the present case.

With these temperature sensors 6, the respective temperature can be determined individually at each DC charging contact 9 or at each AC charging contact 8. The temperature sensors 6 are now connected to the multiplexer 5 in such a way that the temperature signals originating from the temperature sensors 6 are transmitted to the multiplexer 5 so that they can then be converted by the multiplexer into a serial data stream. This serial data stream is then routed via the signal lines 7 to an evaluation unit (not shown in more detail), which is designed separately from the charging connector 1.

In principle, control lines could be connected to the multiplexer 5 in order to control the temporal sequence of the temperature signals, originating from the temperature sensors 6, in the serial data stream. With the help of such control lines, it could thus be determined which temperature sensor 6 data are currently of interest and should therefore be fed to the evaluation unit. In the present case, however, the temperature signals originating from the temperature sensors 6 follow one another periodically in the serial data stream. For example, a sequence of the temperature signals could be provided in which the temperature signals for the two DC charging contacts 9 are followed by the temperature signals for the four AC charging contacts 8, etc., i.e., using the nomenclature from the European standard IEC 62196, the sequence would be “DC+, DC−, L1, L2, L3, N, DC+, . . . . ”

FIG. 4 schematically shows a charging connector 1 according to another preferred exemplary embodiment of the invention with a digital part 16 arranged in the communication module 4 for receiving digital control data. Here, control data are received from outside the charging connector 1 via the signal lines 7 in order to initiate a control for a component of the charging connector 1. This is because in this case, the charging connector 1 has a locking flap 17 with which the opening within which the AC charging contacts 8 and the DC charging contacts 9 are arranged can be closed and locked to the outside. An actuator 10, here in the form of an electric motor, is provided for opening and closing this locking flap 17. The actuator 10 is connected to a control device 11, by means of which the actuator 10 can be controlled such that the locking flap 17 opens or closes. Corresponding signals, which specify an opening or closing of the locking flap 17, are fed to the control device 11 from outside the charging connector, namely via the signal lines 7 and the communication module 4 having the digital part 16. It should also be noted that, in the present case, the communication module 4 is set up for bidirectional communication of serial signals so that it can not only receive signals that specify whether the locking flap 17 should be closed or opened. Rather, it is also possible here for the control device to transmit data that indicate the current position of the locking flap 17, i.e., open or closed, to the digital part 16 of the communication module 4 so that this information can be output in the form of digital data via the signal lines 7.

### LIST OF REFERENCE SIGNS

1 charging connector
2 housing
3 charging contacts
4 communication module
5 multiplexer
6 temperature sensors
7 signal lines
8 AC charging contacts
9 DC charging contacts
10 actuator
11 control device
12 corresponding charging connector
13 corresponding DC charging contacts
14 protective contact
15 signal contacts
16 digital part
17 locking flap

1. A charging connector for an electric or hybrid vehicle, the charging connector comprising:
a housing,
a plurality of charging contacts arranged in the housing for conducting electric current, and
a communication module configured to transmit and/or receive a serial signal.

2. The charging connector according to claim 1, wherein the communication module comprises a multiplexer for multiplexing signals detected in or on the charging connector.

3. The charging connector according to claim 2, wherein each of the plurality of charging contacts includes a temperature sensor for detecting a temperature of the respective each of the plurality of charging contacts, and
wherein the temperature sensors are connected to the multiplexer so that temperature signals originating from the temperature sensors are transmitted to the multiplexer and converted by the multiplexer into a serial data stream.

4. The charging connector according to claim 3, wherein the plurality of charging contacts include AC charging contacts.

5. The charging connector according to claim 1, wherein the communication module has a digital part for receiving digital signals.

6. The charging connector according to claim 1, wherein the communication module is configured for bidirectional communication of serial signals.

7. The charging connector according to claim 1 further comprising an actuator and a control device for controlling the actuator,
wherein the communication module is connected to the control device for transmitting a control signal received from the communication module.

8. The charging connector according to claim 1, wherein the charging connector is a built-in charging plug for attachment to the body of the electric or hybrid vehicle.

9. A use of a charging connector according to claim 1 on the body of an electric or hybrid vehicle.

10. A method for communication between a charging connector for an electric or hybrid vehicle and a device other than the charging connector, wherein the communication takes place by means of a serial signal.

11. The charging connector according to claim 7, wherein the plurality of charging contacts includes at least one AC charging contacts with a first opening and at least one DC charging contacts with a second opening.

12. The charging connector according to claim 11 further includes a locking flap, wherein the locking flap is configured to close the first and second openings.

13. The charging connector according to claim 12, wherein the actuator is an electric motor and is configured to open and/or close the locking flap.

14. The charging connector according to claim 2 further includes plurality of signal lines, wherein the multiplexer is configured to bundle the plurality of signal lines into a single one.
